(19) United States
(12) Patent Application Publication
(10) Pub. No.: US 2026/0341557 A1
(43) Pub. Date: Oct. 29, 2026

(54) Flame-Tight Cable Feedthrough, Container and Rail Vehicle with a Flame-Tight Cable Feedthrough, and Use of a Foam Seal

(71) Applicant: ALSTOM HOLDINGS, St Ouen sur Seine (FR)

(72) Inventors: Peter Heidrich, Ludwigshafen (DE); Detlev Rathmann, Schortens (DE)

(21) Appl. No.: 19/118,370

(22) PCT Filed: Oct. 2, 2023
(86) PCT No.: PCT/EP2023/077258

§ 371 Date: Apr. 4, 2025

(30) Foreign Application Priority Data
Oct. 5, 2022 (EP) 22315231.5

(51) Int. Cl. H01B 17/58; B61D 49/00

(52) U.S. Cl. CPC H01B 17/583; B61D 49/00

(57) ABSTRACT

A flame-tight cable feedthrough includes a bushing having a through opening for guiding at least one cable through a partition wall, and a foam seal made of a foam material for insertion into the through opening of the bushing and for enclosing the at least one cable. The foam seal has at least two concentrically arranged foam rings which can be detached from one another for stepwise adjustment of the clear internal diameter of the foam seal, wherein the foam corresponds to building material class B1 or B2 according to DIN 4102:1998 and foams up under the effect of heat, in particular in the event of a fire.

### CROSS-REFERENCE TO RELATED APPLICATIONS

This application is the United States national phase of International Patent Application No. PCT/EP2023/077258 filed Oct. 2, 2023, and claims priority to European Patent Application No. 22315231.5 filed Oct. 5, 2022, the disclosures of which are hereby incorporated by reference in their entireties.

### BACKGROUND OF THE INVENTION

### Field of the Invention

The disclosure relates to rail vehicle technology and concerns a flame-tight cable feedthrough, a container with a flame-tight cable feedthrough, a rail vehicle with a flame-tight cable feedthrough and the use of a foam seal for a flame-tight cable feedthrough.

### Disclosure of Prior Art

It is well known, for example, that installation spaces or containers of rail vehicles are connected by electrical lines.

For example, these electrical lines are routed inside a cable feedthrough in the form of cable protection hoses and their glands. According to the applicable fire protection standards, for example DIN EN 45545, a rail vehicle manufacturer must prove that cable feedthroughs are smoke gas-and/or flame-tight.

Tightness against smoke gas is associated with greater effort than tightness against flames.

It is also known that rail vehicles undergo design amendments during their service life, which may involve the removal of cable feedthroughs.

Non-destructive detachable cable feedthroughs are known. These can be smoke gas-tight, but offer little flexibility for extensions and are relatively expensive and complex.

For cable feedthroughs that need to be flame-tight but not necessarily smoke gas-tight, cable feedthroughs that are not smoke gas-tight are used in practice, as this often ensures that they are also flame-tight. These cable feedthroughs are filled with suitable paste-like flame retardants after installation in the rail vehicle, for example, so that the requirement for impermeability to flames is met.

Feedthroughs for cables or pipes that have a sealing function, for example against gas, smoke or flames, are described, for example, in CN 210 669 367 U, CN 209 692 322 U, CN 110 474 282 B, KR 10 2019 0 034 712 A, EP 3 448 651 B1, WO 2016/104 20 A1, EP 2 722 572 B1, EP 2 131 085 B1, RU 2 301 096 C1, EP 1 631 358 B1, US 2002/0030326 A1, U.S. Pat. No. 5,634,304 A and EP 0 281 353 A2.

The disadvantage of these solutions is that these cable feedthroughs can no longer be removed non-destructively or only with considerable effort in the event of pending constructive changes, or are structurally complex. This results in increased effort and costs, as the cable feedthroughs are often no longer usable after dismantling.

It is therefore the task of the present invention to provide a sufficiently flame-tight cable feedthrough which is inexpensive to manufacture. Furthermore, a rail vehicle with such a problem-solving cable feedthrough is to be presented.

### SUMMARY OF THE INVENTION

This task is solved by a flame-tight cable feedthrough described herein, by a container with such a flame-tight cable feedthrough described herein, by a rail vehicle with such a flame-tight cable feedthrough described herein, and by the use of a foam seal for a flame-tight cable feedthrough described herein. Further embodiments, designs and advantages are also described in the following description.

According to one aspect of the present invention, a flame-tight cable feedthrough is provided, wherein the flame-tight cable feedthrough is for passing at least one cable through a partition wall. The flame-tight cable feedthrough includes a bushing with a through opening and a foam seal made of a foam for inserting into the through opening of the bushing and for enclosing the at least one cable, wherein the foam seal includes at least two, in particular at least three, preferably at least four, particularly preferably at least five, concentrically arranged foam rings which are detachable from one another. The foam rings can be detached from each other in such a way that the inside diameter of the foam seal can be step-wise adjusted. In particular, a foam made of a material that meets the requirements of building material class B1 or B2 in accordance with DIN 4102:1998 is used and continues to foam under the effect of heat, in particular in the event of a fire. The material of the foam is therefore an intumescent material.

The foam seal is a moulded part, i.e. the foam seal has a predetermined shape, is dimensionally stable but elastically deformable. The foam seal must be distinguished from foamed materials, which are pressed out of a tube at the installation site, for example, and foam up and fill cavities. Such foamed materials are not moulded parts. In contrast to foamed materials, moulded parts are easier to handle and can be inserted more quickly and reliably into the bushing of cable feedthrough.

The flame-tight cable feedthrough does not necessarily have to be smoke gas-tight in accordance with EN45545-3. For many applications, it is sufficient for the cable feedthrough to be flame-tight in accordance with EN45545-2. This makes it possible to use suitable foams. Expensive and time-consuming smoke gas-tight materials can be dispensed with. This not only saves costs, but also reduces the installation effort.

The bushing can have an outer diameter that essentially corresponds to the diameter of a bore or an opening through the partition wall. Essentially means that corresponding fits can also be provided, for example to fix the bushing in the bore in the partition wall using an interference fit without further fastening means.

According to some embodiments, the bushing may also have, for example, a shoulder on its outer circumference that abuts against a first side of the partition wall when the cable feedthrough is inserted into the partition wall. On a second side of the partition wall, for example, a fastening means can be provided to firmly connect the bushing to the partition wall. In particular, the bushing can have an external thread for this purpose in order to fasten the bushing to the partition wall with a nut. For example, according to a further embodiment, the bushing can have at least one groove for holding a first retaining ring. The bushing can be fixed in the bore in the partition wall by the first retaining ring.

According to some embodiments, the bushing can be flush with the partition wall on one or both sides.

The foam seal can be inserted into the through opening of the bushing. According to some embodiments, the through opening can be continuous (with a constant inner diameter); according to further embodiments, a shoulder can be present on an inner circumference with an inner diameter ID, for example, which can serve as a stop for the foam seal. According to some embodiments, the bushing can have at least one groove on the inner circumference for holding a second retaining ring. The foam seal can be fixed inside the bushing by the second retaining ring.

The foam typically has a large number of closed pores, which gives the foam an elastic resilience.

According to some embodiments, the foam seal on the outermost foam ring can have an outer diameter dn greater than the inner diameter ID of the bushing, so that the foam seal can be inserted into the through opening under slight compression. This embodiment offers the advantage that the foam seal remains frictionally fixed in the through opening of the bushing without any further fastening means. For example, the outermost foam ring can be glued to the bushing at the through opening.

The foam of the foam seal corresponds, for example, to building material class B1 or B2 in accordance with DIN 4102:1998 and can also have the property of foaming up under thermal influence, in particular in the event of a fire, in such a way that the cable feedthrough prevents a flame from passing through.

It is not necessarily necessary to protect the at least one cable from catching fire itself when it is under thermal influence. Furthermore, the present invention is not concerned with fulfilling the higher requirement of impermeability to smoke gas. The present invention is expressly not necessarily concerned with ensuring impermeability to smoke gas. Rather, the present invention is concerned with ensuring that a flame on the first side of the partition wall cannot flash over to the second side of the partition wall through the flameproof cable feedthrough. The cable feedthrough therefore does not have to be smoke gas tight.

According to some embodiments, the diameter of the concentrically arranged foam rings can be selected such that they correspond to standard cable diameters and/or standard cable bundle diameters. Depending on the diameter of a cable to be fed through or a cable bundle to be fed through, at least one or no inner foam ring can be removed during assembly, for example. This makes it possible to stepwise adjust the clear inner diameter of the foam seal. Furthermore, a subsequent extension, i.e. the insertion of further cables and/or cable bundles through the already mounted flame-tight cable feedthrough, is made possible. For example, at least one foam ring is removed.

According to some embodiments, the diameters can also be selected in such a way that the foam seal is slightly compressed when the at least one cable is inserted or pushed in. This ensures that no cavities can form that could favour a flashover. In the event of a fire, the foam continues to expand under the influence of temperature (heat of the fire) and expands to cover the entire available space, further improving protection against flashover. After a fire, the cable feedthrough, i.e. in particular the foam seal and the bushing, and possibly also the cable, must be replaced.

According to some embodiments, lateral insertion of the at least one cable can be made possible by the foam rings each having a longitudinal slot. According to some embodiments, the longitudinal slits are arranged offset in the circumferential direction. The foam ring can be cut open along the longitudinal slot so that the at least one cable can be inserted.

If required, the concentric rings can be slotted lengthwise, which also allows them to be retrospectively fitted. Care must be taken here to ensure that there is no slot over slot during assembly. If the individual rings are arranged in such a way that their longitudinal slots are offset to each other in the circumferential direction, this is advantageous for preventing flame transmission in the event of a fire. If cables are to be added later, space can be created by removing the corresponding ring elements. The longitudinal slots are preferably continuous, both in the longitudinal direction (parallel to the axis of the rings) and in the thickness direction (radial direction) of the rings.

According to some embodiments, the non-compressed foam rings may also have an oversize in their outer diameter compared to the inner diameter of the next larger foam ring. In some embodiments, the foam rings can be glued to each other, in particular after inserting or pushing in the at least one cable. This ensures, for example, that individual foam rings can no longer come loose, so that the flame-tight cable feedthrough remains functional at all times.

According to some embodiments, the flame-tight cable feedthrough may further include a cable protection hose connectable to a front end of the bushing to loosely guide the at least one cable onward from the bushing. The cable protection hose can also have a hose and a fastening ring, for example. The hose can be connected to the fastening ring. The fastening ring can be used to connect the cable protection hose to the bushing in a non-destructive, detachable manner.

For the first time, the present invention enables non-destructive disassembly of the flame-tight cable feedthrough with a simultaneously less complex structure than existing cable feedthroughs from the prior art that meet the requirement of smoke gas-tightness. As a result, costs can be saved when purchasing and making design amendments that require the cable feedthrough to be dismantled.

According to a further aspect of the disclosure, there is disclosed a container or rail vehicle having a flame-tight cable feedthrough according to one or a combination of the embodiments described above.

Rail vehicles are in particular trains, subway trains, metros, trams, high-speed trains or similar. In particular, the cable feedthrough is inserted into a through opening of a partition wall, e.g. housing wall, of a container or installation space. Preferably, the container or the installation space is arranged outside the car body or the passenger area of the rail vehicle, e.g. below the car body or above the car body on the roof of the rail vehicle. The rail vehicle therefore has, in particular, a car body with a passenger area and an installation space or container which is attached to the outside of the car body. By using the flame-tight cable feedthrough described here, the protection required by EN45545-2 against the potential spread of flames can be achieved in a simple, cost-effective and advantageous manner.

According to a further aspect, the use of a foam seal made of a foam material of building material class B1 or B2 according to DIN 4102:1998 for insertion into a through opening of a bushing and for enclosing and guiding at least one cable through a partition wall is disclosed, so that a flame-tight cable feedthrough is made possible. The foam seal has at least two foam rings which can be detached from one another for stepwise adjustment of the clear inside diameter of the foam seal. The foam also has the property of foaming up when exposed to heat, in particular in the event of a fire.

The foam rings have different inner and outer diameters and are preferably arranged coaxially to one another, with the foam ring with the larger outer diameter surrounding the foam ring with the next smallest outer diameter. Each foam ring can have a longitudinal slot running in the axial direction in order to open the foam ring and insert the cable(s). The foam rings are preferably arranged in such a way that the longitudinal slots of the individual foam rings are offset from one another in the circumferential direction. For example, the longitudinal slots of adjacent foam rings can be offset from one another by at least 30°, preferably by at least 45°, and even more preferably by at least 60°.

The embodiments described above can be combined with one another as desired, but in a sensible manner; in particular, the flame-tight cable feedthrough described can be used in a rail vehicle to feed at least one cable through a partition wall of an installation space or a container.

### BRIEF DESCRIPTION OF THE DRAWINGS

The terms Fig., Figs., Figure, and Figures are used interchangeably in the specification to refer to the corresponding figures in the drawings.

In the following, the invention is explained in more detail by means of embodiments, without these being intended to limit the scope of protection defined by the protective claims.

The accompanying drawings illustrate embodiments and, together with the description, serve to explain the principles of the invention. The elements of the drawings are relative to each other and not necessarily to scale. Identical reference signs denote similar parts.

FIG. 1 shows a sectional view of a flame-tight cable feedthrough according to one embodiment.

FIG. 2 shows a cable feedthrough according to another embodiment in a sectional view.

FIG. 3 shows foam rings according to some embodiments in an end view.

### DESCRIPTION OF THE INVENTION

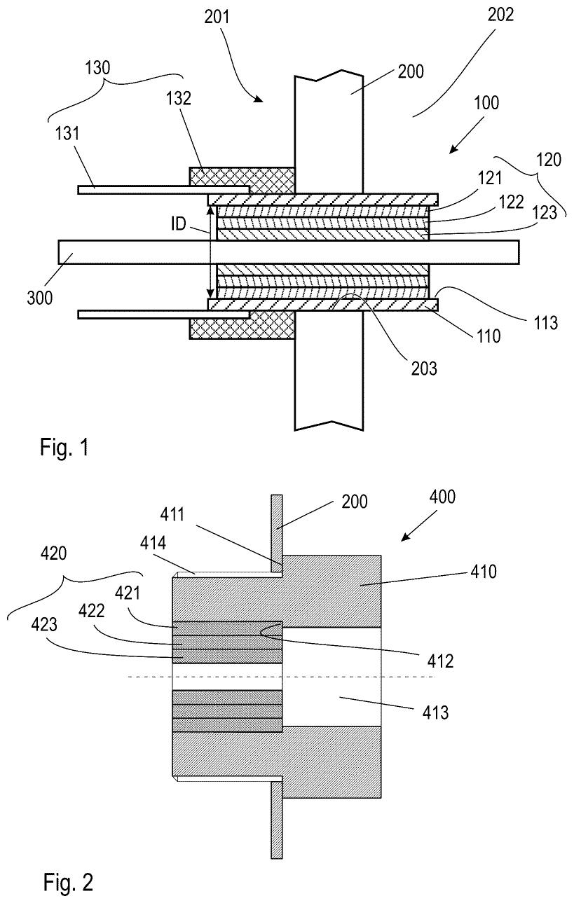

FIG. 1 shows a flame-tight cable feedthrough 100 with a bushing 110 according to some embodiments. The bushing 110 may be inserted into a through opening 203 in a partition wall 200 and through the partition wall 200 from a first side 201 of the partition wall 200. The bushing 110 passes completely through the partition wall 200 and extends, for example, but not necessarily, beyond a second side 202 of the partition wall 200. According to some embodiments, the bushing 110 may have a fit to the through opening 203, which is for example in the form of a bore 203 (shown in FIG. 1) or an opening (not shown) through the partition wall 200. In particular, an interference fit can be provided so that the bushing 110 can be fixed in the bore 203 without further fastening means. The bushing 110 may have a length that is at least equal to the thickness of the partition wall 200. In particular, the bushing 110 can have a length that is greater than the thickness of the partition wall 200. It is also conceivable that the bushing 110 has a shorter length than the partition wall 200. Typically, the bushing 110 protrudes beyond both sides 201, 202 of the partition wall 200 and therefore has a length that is greater than the thickness of the partition wall 200.

According to additional or alternative embodiments, the bushing 110 can have at least one circumferential groove on the outside, which can be used for positioning at least one retaining ring, so that the bushing 110 is fixed within the bore 203 in a non-destructive removable manner. According to some embodiments, the bushing 110 has a shoulder on its outer circumference so that the position of the bushing 110 on the partition wall 200 is fixed in one direction. This is shown in more detail below in FIG. 2.

At least two, in particular at least three, foam rings 121, 122, 123 may be arranged in a through opening 113 of the bushing 110, forming a foam seal 120. The foam seal 120 may have a shorter length than the bushing 110 and may or may not be positioned centered within the through opening 113 of the bushing 110. In particular, the foam seal 120 may have substantially the same length as the bushing 110. The foam seal 120, having an outer diameter dn of the outermost foam ring 121, may for example be installed under compression into the through opening 113 of the bushing 110, having for example an inner diameter ID smaller than the outer diameter of the outermost uncompressed foam ring dn. This ensures that the foam seal 120 can be sufficiently frictionally fixed within the bushing 110 without the need for additional fasteners. The number of foam rings required results from the inner diameter ID of the bushing (110), the wall thickness of the individual foam rings, and the total thickness of the cables 300 to be fed through. The individual foam rings may have a uniform wall thickness, or each may have a different wall thickness.

The embodiment shown in FIG. 1 has a through opening 113 of the bushing 110 with a constant inner diameter throughout.

The foam seal 120 may additionally or alternatively, according to some embodiments, be retained within the bushing 110 by fastening means. For example, at least one stop may be provided within the through opening 113 of the bushing 110, i.e., a shoulder may be provided on an inner circumference of the through opening 113 having an inner diameter ID, which serves as a stop for the foam seal 120. This is shown in more detail below in FIG. 2.

The foam seal 120 can, for example, be installed in a compressed state and can be fixed within the through opening 113 of the bushing 110 both in a frictionally engaged manner and in an axially immovable manner by means of stops on one or both sides. The at least one stop can be provided at the respective ends of the bushing 110 and/or within the through opening 113. According to alternative or additional embodiments, it is also conceivable to secure the foam seal 120 within the through opening 113 by retaining rings. For this purpose, at least one circumferential groove may be provided within the bushing 110.

According to some embodiments, the outermost foam ring 121 within the through opening 113 of the bushing 110 may be bonded to the bushing 110 so that the foam seal 120 is fixed within the through opening 113. Further or alternatively, the foam rings 121, 122, 123 may also be bonded to each other. In the event of a design amendment in which the flame-tight cable feedthrough 100 or at least the foam seal 120 must also be dismantled, the bonded foam seal 120 can be destructively dismantled and may have to be replaced during reinstallation. However, it is also possible to leave the bushing 110 in the partition wall and only replace the foam seal 120 if, for example, a cable is replaced.

The removal and installation as well as the assembly of the entire flame-tight cable feedthrough 100 can be simplified by bonding the foam seal 120 to the bushing 110, thus saving costs.

The foam of the foam seal 120 can, for example, correspond to a building material of class B1 or B2 according to DIN 4102:1998. Furthermore, the foam may have the property of foaming up under thermal influence. According to some embodiments, the foam material may additionally or alternatively have a resistance to flames. In particular, in the event of a fire, the resulting thermal effect can cause the foam to foam up in such a way that any cavities that may still be present within the bushing 110 are closed and flame transmission from the first side of the partition wall 201 to the second side of the partition wall 202, or vice versa, is effectively prevented.

Through the bushing 110 and the foam seal 120, a cable 300 and/or a cable bundle can be routed from the first side 201 of the partition wall 200 to the second side 202 of the partition wall 200. According to some embodiments, the cable 300 and/or cable bundle is routed through the already assembled flame-tight cable feedthrough 100. According to some alternative or additional embodiments, the cable 300 and/or the cable bundle is guided together with the foam seal 120 through opening of the bushing 110 already installed in the partition wall 200.

Depending on an overall diameter of the cable 300 and/or cable bundle, none or at least one foam ring 121, 122, 123 is removed when the cable 300 and/or cable bundle is passed through the opening of the bushing 110. According to some embodiments, at least one foam ring 121, 122, 123 may be subsequently removed when at least one further cable and/or cable bundle is subsequently added. This makes it possible to adapt the clear internal diameter of the flame-tight cable feedthrough 100. In particular, such an adaptation of the clear inner diameter may also be possible subsequently, i.e. after an initial assembly of the flame-tight cable feedthrough 100 in the partition wall 200.

Further shown on the first side 201 of the partition wall in FIG. 1 is a cable protection hose 130, which may include a hose 131 and a fastening ring 132. The attachment ring 132 may be connected to the hose 131, and may further provide a releasable connection between the hose 131 and the bushing 110 and/or the partition wall 200. The hose 131 may be designed such that the hose 131 encloses the bushing 110 and thus also the cable 300. The cable 300 may, for example, continue loosely through the hose 131.

With reference to FIG. 2, a further embodiment of a flame-tight cable feedthrough 400 is described. The cable feedthrough 400 includes a bushing 410 having a through opening 413, for example in the form of a bore. The bushing 410 passes through an opening, e.g. a bore, in a partition wall 200. On the inner circumference of the through opening 413, an inwardly projecting shoulder is formed to form a stop 412 (inner stop or inner projection). This inner stop 412 or inner projection 412 serves as a stop for the foam seal 420 when it is inserted into the through opening 413.

In the embodiment shown in FIG. 2, the inside diameter of the through opening 413 from the inner stop 412 (shoulder) is consistently smaller than in front of the inner stop 412. Alternatively, the inside diameter can also be the same on both sides of the inner stop 412. In this case, the inner stop 412 is not in the form of a shoulder but in the form of a ring or a bead.

The foam seal 420 has a plurality of foam rings 421, 422, 423 arranged concentrically to one another. At least two foam rings 421, 422, 423, preferably at least three foam rings 421, 422, 423 or even at least four foam rings 421, 422, 423 are provided.

The bushing 410 has an outwardly facing shoulder 411 (outer shoulder or outer projection) on its outer circumference, which can also be in the form of a shoulder, as shown in FIG. 2, or in the form of an outwardly extending projection or an outwardly extending bead (not shown). The outer circumference of the bushing 410 can have a different outer diameter on both sides of the outer shoulder or outer projection 411. In FIG. 2, the portion to the left of the outer shoulder 411 has a smaller outer diameter. In addition, this portion is provided with an external thread 414. The bushing 410 can be inserted with the portion with the smaller outer diameter through the through opening of the partition wall 200 and then secured by a nut, or other securing device. The position of the bushing 410 relative to the partition wall 200 is defined by means of the shoulder 411.

To secure the cable (not shown in FIG. 2), a cable protection hose 130 described above may be provided. It is possible to provide a cable protection hose on only one of the two sides of the bushing 410, or on both. In order to avoid the use of cable protection hoses of different sizes, the bushing may have the same outer diameter on both ends. In this case, the outer shoulder 411 is in the form of an outwardly pointing projection or bead.

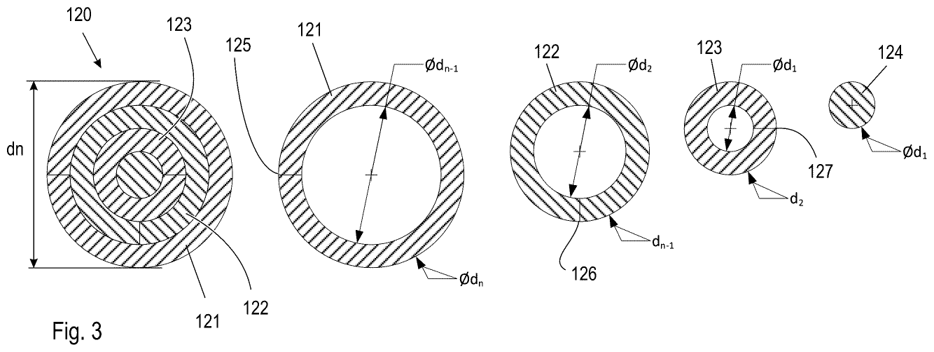

FIG. 3 shows a front view of a foam seal 120 having foam rings 121, 122, 123 and a foam circle 124 according to some embodiments. According to some embodiments, the foam seal 120 may include three foam rings 121, 122, 123 and a foam cylinder 124, which may be cut, for example, from a foam sheet of a suitable thickness, for example via water jet cutting. The thickness of the foam sheet corresponds, for example, approximately to the length of the bushing. The foam rings 121, 122, 123 can each have a longitudinal slot 125, 126, 127 arranged offset to one another in the circumferential direction, as well as having an inner diameter and an outer diameter. In some embodiments, the inner diameter of the innermost foam ring 123 corresponds to the diameter of the foam cylinder 124. The inner diameter of the next outermost foam ring 122, 123 may correspond to the outer diameter of the next innermost foam ring 121, 122. All foam rings 121, 122, 123 and the foam cylinder 124 can be cut from the same foam sheet.

The foam seal with its foam rings 121, 122, 123 can, for example, be a polyurethane foam, in particular a polyurethane foam that foams up in the event of fire. A suitable material is, for example, Flammadur® F500, which is a polyurethane foam that foams up in the event of fire and fulfils building material class B2 according to DIN 4102:1998. The polyurethane foam can consist of two components of polyurethane resin with filler components.

Although specific embodiments have been shown and described herein, it is within the scope of the present invention to suitably modify the embodiments shown without departing from the scope of protection of the present invention. The following claims represent a first, non-binding attempt to define the invention in general terms.

1. A flame-tight cable feedthrough, comprising:
a bushing having a through opening for passing at least one cable through a partition wall, and
a foam seal made of a foam material for insertion into the through opening of the bushing and for enclosing the at least one cable, wherein the foam seal has at least two concentrically arranged foam rings which can be detached from one another for stepwise adjustment of the clear inside diameter of the foam seal, and
wherein the foam material corresponds to building material class B1 or B2 in accordance with DIN 4102:1998 and foams up under thermal influence.

2. The flame-tight cable feedthrough according to claim 1, wherein the through opening has an inner diameter ID at least in one section and the outermost foam ring has an outer diameter dn which is larger than the inner diameter ID, so that the outermost foam ring can be inserted into the through opening under compression.

3. The flame-tight cable feedthrough according to claim 1, further comprising a cable protection hose connectable to a front end of the bushing for loosely guiding the cable from the bushing.

4. The flame-tight cable feedthrough according to claim 3, wherein the cable protection hose comprises a hose and a fastening ring which is connected to the hose and which serves to detachably connect the cable protection hose to the bushing.

5. The flame-tight cable feedthrough according to claim 1, wherein the foam of the foam seal is a polyurethane foam.

6. The flame-tight cable feedthrough according to claim 1, wherein the foam rings each have a longitudinal slit along which the respective foam ring can be separated in order to insert the cable.

7. The flame-tight cable feedthrough according to claim 6, wherein the longitudinal slits of the foam rings are arranged offset from each other in a circumferential direction.

8. The flame-tight cable feedthrough according to claim 6, wherein the foam rings are bonded to one another and/or the outermost foam ring is bonded to the bushing at the through opening.

9. The flame-tight cable feedthrough according to claim 1, wherein the foam rings are individually removable from the bushing.

10. A container, comprising:
a partition wall for separating an inner region of the container from an outer region, the partition wall having a through opening;
a flame-tight cable feedthrough inserted in the through opening, the flame-tight cable feedthrough comprising
a bushing having a through opening for passing at least one cable through the partition wall, and
a foam seal made of a foam material for insertion into the through opening of the bushing and for enclosing the at least one cable, wherein the foam seal has at least two concentrically arranged foam rings which can be detached from one another for stepwise adjustment of the clear inside diameter of the foam seal, and
the foam material corresponding to building material class B1 or B2 in accordance with DIN 4102:1998 and foams up under thermal influence; and
at least one cable guided from the outer region through the flame-tight cable feedthrough into the inner region of the container, wherein the bushing of the flame-tight cable feedthrough penetrates the partition wall and the at least one cable is enclosed in the through opening of the bushing by the foam seal and the foam seal closes the through opening, wherein the foam seal can be removed from the through opening in a non-destructive manner.

11. A rail vehicle, comprising
at least one of an installation space or a container each having a partition wall;
a flame-tight cable feedthrough comprising:
a bushing having a through opening for passing at least one cable through the partition wall, the bushing penetrating the partition wall, and
a foam seal made of a foam material for insertion into the through opening of the bushing and for enclosing the at least one cable, wherein the foam seal has at least two concentrically arranged foam rings which can be detached from one another for stepwise adjustment of the clear inside diameter of the foam seal, and
the foam material corresponding to building material class B1 or B2 in accordance with DIN 4102:1998 and foams up under thermal influence; and
at least one cable passing through the partition wall of the at least one installation space or container,
wherein the at least one cable is enclosed in the through opening of the bushing by the foam seal and the foam seal closes the through opening, wherein the foam seal can be removed from the through opening in a non-destructive manner.

12. Use of a foam seal made of a foam material for a flame-tight cable feedthrough, wherein the foam seal has at least two concentrically arranged foam rings which can be detached from one another for stepwise adjustment of the clear internal diameter of the foam seal, and wherein the foam material corresponds to building material class B1 or B2 according to DIN 4102:1998, and foams up under thermal action, for insertion into a through opening of a bushing and for enclosing and guiding at least one cable through a partition wall in such a way that a flame-tight cable feedthrough is made possible.

13. The rail vehicle according to claim 11, wherein the through opening has an inner diameter ID at least in one section and the outermost foam ring has an outer diameter dn which is larger than the inner diameter ID, so that the outermost foam ring can be inserted into the through opening under compression.

14. The rail vehicle according to claim 11, further comprising a cable protection hose connectable to a front end of the bushing for loosely guiding the cable from the bushing.

15. The rail vehicle according to claim according to claim 14, wherein the cable protection hose comprises a hose and a fastening ring which is connected to the hose and which serves to detachably connect the cable protection hose to the bushing.

16. The rail vehicle according to claim 11, wherein the foam of the foam seal is a polyurethane foam.

17. The rail vehicle according to claim 11, wherein the foam rings each have a longitudinal slit along which the respective foam ring can be separated in order to insert the cable.

18. The rail vehicle according to claim 17, wherein the longitudinal slits of the foam rings are arranged offset from each other in a circumferential direction.

19. The rail vehicle according to claim 17, wherein the foam rings are bonded to one another and/or the outermost foam ring is bonded to the bushing at the through opening.

20. The rail vehicle according to claim 11, wherein the foam rings are individually removable from the bushing.
